(19) United States
(12) Patent Application Publication
(10) Pub. No.: US 2018/0322499 A1
(43) Pub. Date: Nov. 8, 2018

(54) MATCHING TRANSACTION INFORMATION FOR PAYMENT

(71) Applicant: HEWLETT-PACKARD DEVELOPMENT COMPANY, L.P., Houston, TX (US)

(72) Inventors: Syed S. Azam, Houston, TX (US); Manny Novoa Houston, Houston, TX (US); James R. Waldron, Houston, TX (US)

(21) Appl. No.: 15/749,017

(22) PCT Filed: Dec. 17, 2015
(86) PCT No.: PCT/US2015/066439

§ 371 Date: Jan. 30, 2018

(51) Int. Cl. G06Q 20/40; G06Q 20/32; G06Q 20/42

(52) U.S. Cl. CPC G06Q 20/4016; G06Q 20/3276; G06Q 20/20; G06Q 20/40145; G06Q 20/42

(57) ABSTRACT

In example implementations, an apparatus comprising a processor and a non-transitory computer-readable storage medium. The instructions when executed by the processor cause the processor to receive a machine readable code generated by a retailer that includes transaction information, decipher the transaction information from the machine readable code, transmit the transaction information to a third party financial service provider and receive a confirmation that payment has been made to the retailer for a transaction based upon a match of the transaction information to additional transaction information that was sent from the retailer to the third party financial service provider.

### BACKGROUND

In the United States millions of retail transactions occur every day. A user swipes his or her credit card at a point of sale (POS) device at the retailer to purchase an item or provides credit card information to a website for online orders. These types of transactions leave a footprint of the credit card information of the user for unscrupulous individuals to steal. This can lead to fraudulent transactions or identity theft.

### BRIEF DESCRIPTION OF THE DRAWINGS

FIG. 1 is a block diagram of an example system of the present disclosure;

FIG. 2 is an example of an apparatus of the present disclosure;

FIG. 3 is another example of an apparatus of the present disclosure;

FIG. 4 is a flow diagram of an example method for matching transaction information for payment from a perspective of a consumer;

FIG. 5 is a flow diagram of an example method for matching transaction information for payment from a perspective of a retailer;

FIG. 6 is a flow diagram of an example method for matching transaction information for payment from a perspective of a third party financial service provider; and

FIG. 7 is a flow diagram of an example method for pre-paying a retailer for an item.

### DETAILED DESCRIPTION

The present disclosure discloses a system and method for performing a cash-less and card-less transaction between a consumer and a retailer. The system and method of the present disclosure perform the transaction without leaving any “footprints” of the transaction that can be stolen leading to fraudulent transactions or identity theft.

In addition, the systems and methods of the present disclosure can be deployed without additional hardware at the retailer. In other words, the retailer can use the existing hardware. The consumer may use his or her mobile endpoint device that has be modified with an application to execute the functions of the method described herein.

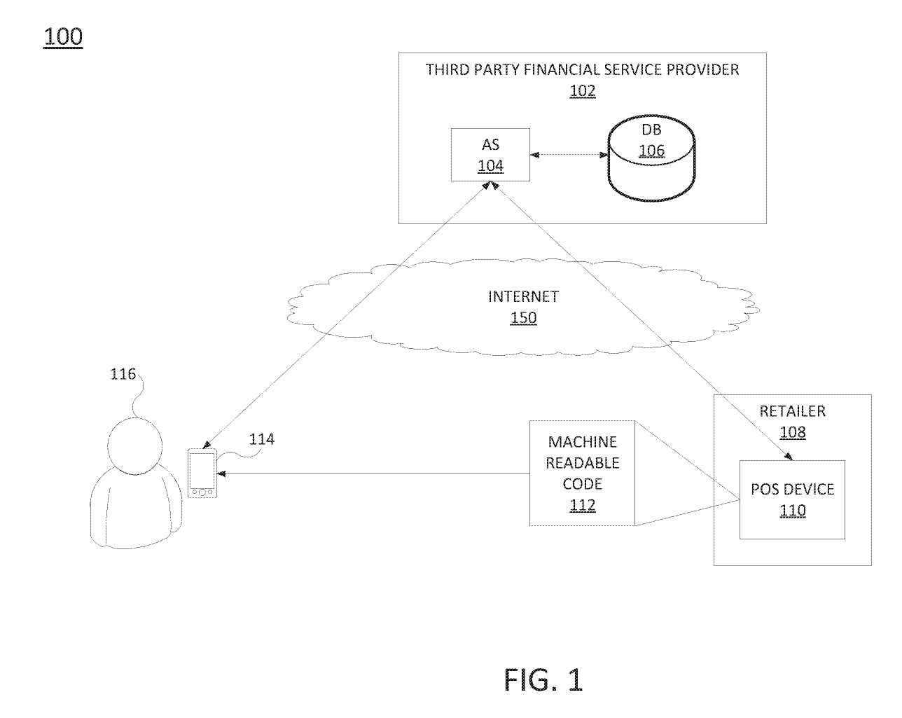

FIG. 1 illustrates an example system 100 of the present disclosure. The system 100 may include a third party financial service provider (TPFSP) 102, a retailer 108 and a consumer 116 with an endpoint device 114. In one example, the TPFSP 102 may include an application server (AS) 104 and a database (DB) 106. The TPFSP 102 may be a bank, a clearing house, a financial service branch of a retailer, a credit card company, and the like.

The AS 104 may include a processor and a non-transitory computer readable storage medium for storing instructions to be executed by the processor to perform the functions described herein. The DB 106 may store various information including consumers 116 who are customers of the TPFSP 102 and financial account information associated with each consumer 116.

In one example, the retailer 108 may be a brick and mortar retailer or an online retailer and may include a point of sale (POS) device 110. The POS device 110 may be a cash register/scanning system, a credit card terminal device, a server that hosts a webpage interface for online retailers, and the like. The POS device 110 may include a processor and a non-transitory computer readable storage medium for storing instructions to be executed by the processor to perform the functions described herein.

The POS 110 may be able to generate a machine readable code 112 that can be scanned by the mobile endpoint device 114. In one example, the machine readable code 112 may be a quick response (QR) code. The machine readable code 112 may contain transaction information associated with an item or service that is purchased by the consumer 116. The transaction information may include a store identification (e.g., a store name, a store number, and the like), a transaction identification (e.g., a unique numerical value associated with a particular transaction), an amount (e.g., a total amount of the transaction), and the like.

In some implementations, the machine readable code 112 may be generated on a printed receipt. In other implementations, the machine readable code 112 may be generated and displayed on a display of the POS device 110. In other examples, the machine readable code 112 may be displayed on a check out webpage of an online transaction.

In one example, the consumer 116 uses the endpoint device 114 to scan the machine readable code 112 to complete a transaction. The endpoint device 114 may be a mobile endpoint device, such as for example, a smart phone, a tablet computer, a lap top computer, and the like. In some implementations where the endpoint device 114 is unable to scan the machine readable code 112, the machine readable code 112 may be verbally provided or manually input into the endpoint device 114. For example, the machine readable code 112 may include a numerical code or bar code that has a numerical value that can be read or typed into the endpoint device 114.

In one example, the endpoint device 114 may have a camera to capture the machine readable code 112 and a global positioning system (GPS) radio or receiver to track a location of the endpoint device 114. The endpoint device 114 may also be modified to execute an application issued by the TPFSP 102 to perform the cash-less/card-less transaction. The application may register the consumer 116 with a log in and password information that are stored in the DB 106 of the TPFSP 102.

In one implementation, the application on the endpoint device 114 may decipher the transaction information contained in the machine readable code 112. The application on the endpoint device 114 may then send the deciphered transaction information along with a GPS location of the endpoint device 114 and a user identification (e.g., obtained from the log in to the application) to the TPFSP 102. In one example, the application on the endpoint device 114 may encrypt the transmission. The transaction information may be transmitted via either a wired or wireless communication over the Internet 150.

In parallel, the retailer 108 may send transaction information to the TPFSP 102. For example, the consumer 116 may select an option for a cash-less/card-less transaction on the POS device 110. The consumer 116 may provide a name of the TPFSP 102 and the POS device 110 may send a wired or wireless communication containing the transaction information to the TPFSP 102. In one example, the transaction information sent by the retailer 108 may include financial account information associated with the retailer 108 to receive funds or payment (e.g., an account number and a routing number for electronic payment), a store identification, a store location, a transaction identification and an amount.

In one implementation, if the transaction is an online purchase via a website, the store location information may be a virtual location. For example, the store location may be the location of the endpoint device 114 of the consumer 116. For example, the retailer 108 may know the location of the endpoint device 114 of the consumer 116 via an internet protocol (IP) address of the endpoint device 114. In another example, the store location may be a home address of the consumer 116 based upon log in information of the consumer 116 to an online webpage of the retailer 108. Otherwise, for a brick and mortar or physical retailer 108, the store location may be a GPS location of the retailer 108 or an address.

The TPFSP 102 may then compare the transaction information received from the endpoint device 114 and the retailer 108 to determine if the transaction information matches. For example, the TPFSP 102 may determine whether the GPS location of the endpoint device 114 and the store location information match within a threshold (e.g., within 100 feet of the estimated location of the endpoint device 114 and the store location address, within 10 degrees of the GPS coordinates of the endpoint device 114 and the store location, and the like). The TPFSP 102 may determine whether the transaction ID and the amount received from the endpoint device 114 and the retailer 108 match, and so forth.

If the transaction information from the endpoint device 114 and the transaction information from the retailer 108 match, then the TPFSP 102 may transfer funds from a financial account of the consumer 116 to a financial account of the retailer 108. The TPFSP 102 may then send a confirmation to the endpoint device 114 and the POS device 110 indicating that the transaction is completed. The consumer 116 may then take the items or receive the services from the retailer 108.

Notably, during the transaction described above, the consumer 116 does not provide information to the retailer 108. The retailer receives no personal or financial account information from the consumer 116 to complete the transaction. In addition, the transaction described can be implemented using existing hardware of the retailer 108.

Furthermore, the transaction described above provides no motivation for an unscrupulous user to try and steal or intercept the machine readable code 112. For example, if another user captured the machine readable code 112 via his or her device, the user would be log in to his or her own TPFSP 102 and pay for the items instead of the consumer 116.

In one illustrative scenario, a consumer 116 may be forced by a thief to scan the machine readable code 112 using the endpoint device 114 of the consumer. However, in one example a user defined distress signal may be transmitted that indicates the transaction information is being transmitted under distress. For example, the distress signal may be a pre-defined keystroke pattern or numerical code that is entered in the application. The distress signal would notify the TPFSP 102 to cancel the transaction and allow the TPFSP 102 to contact authorities (e.g., the police) to the location of the transaction (e.g., based on the store location information that was received in the transaction information or the GPS location of the endpoint device 114 that was received).

In some implementations, an amount threshold may be assigned to each fingerprint to prevent inadvertent transactions. For example, the endpoint device 114 may have a fingerprint sensor that can identify the fingerprint of different fingers of the consumer 116. A thumb may be assigned to a limit of $50, the index finger may be assigned a limit of $100, and so forth. The consumer 116 may transmit the transaction information to the TPFPS 102 with a confirmation of an index finger fingerprint scan on the endpoint device 114. The consumer 116 may have believed the total purchase was for $79. However, the total may have been for $790. The TPFSP 102 may deny the transaction since the consumer 116 authorized a transaction limit of $100.

In some implementations, the system 100 may also be used to pre-pay for items or services sold by the retailer 108. For example, the consumer 116 may send a request to the TPFPS 102 for pre-payment to the retailer 108 via the endpoint device 114. The request may include a name of the retailer 108, the location of the retailer 108, an amount, and the like.

The TPFPS 102 may transfer funds from the financial account of the consumer 116 to the financial account of the retailer 108 per the request. The TPFPS 102 may then generate and transmit a machine readable code (e.g., a QR code) to the endpoint device 114 that includes confirmation of the pre-payment to the retailer 108.

The consumer 116 may then display the machine readable code to the retailer 108 so that the retailer 108 can scan and decipher the machine readable code (e.g., using a scanner that is part of the POS device 110). Alternatively for an online transaction, the consumer 116 may electronically transmit the machine readable code to the retailer 108. The retailer 108 may read the confirmation in the machine readable code and provide the items or services to the consumer 116.

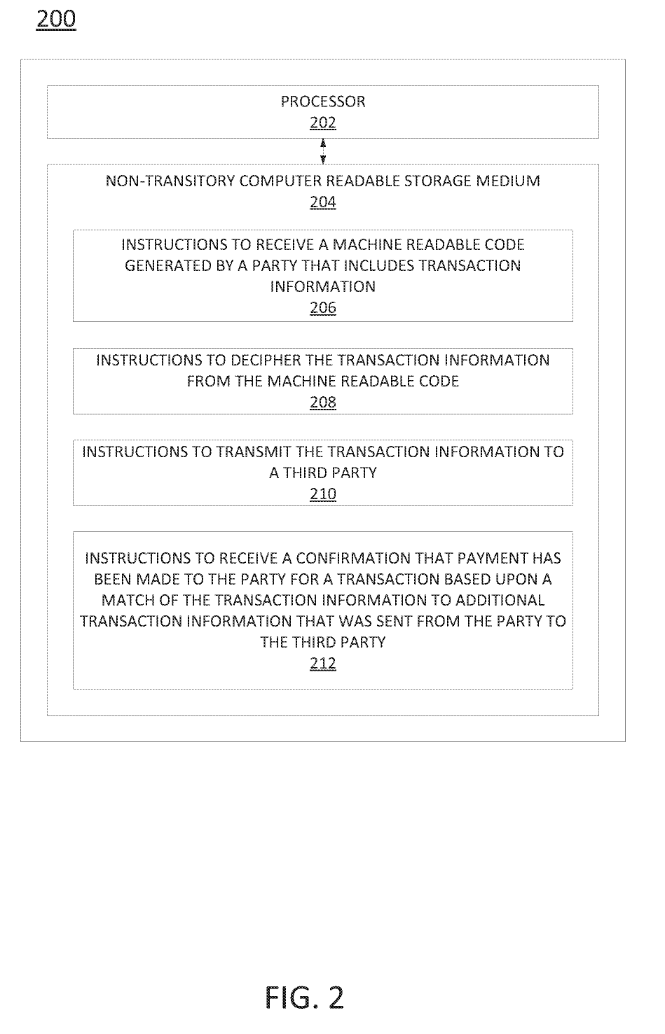

FIG. 2 illustrates an example of an apparatus 200. In one example, the apparatus may be the endpoint device 114. In one example, the apparatus 200 may include a processor 202 and a non-transitory computer readable storage medium 204. The non-transitory computer readable storage medium 204 may include instructions 206, 208, 210 and 212 that when executed by the processor 202, cause the processor 202 to perform various functions.

In one example, the instructions 206 may include instructions to receive a machine readable code generated by a party (e.g., a retailer) that includes transaction information. The instructions 208 may include instructions to decipher the transaction information from the machine readable code. The instructions 210 may include instructions to transmit the transaction information to a third party (e.g., a third party financial service provider). The instructions 212 may include instructions to receive a confirmation that payment has been made to the party for a transaction based upon a match of the transaction information to additional transaction information that was sent from the party to the third party.

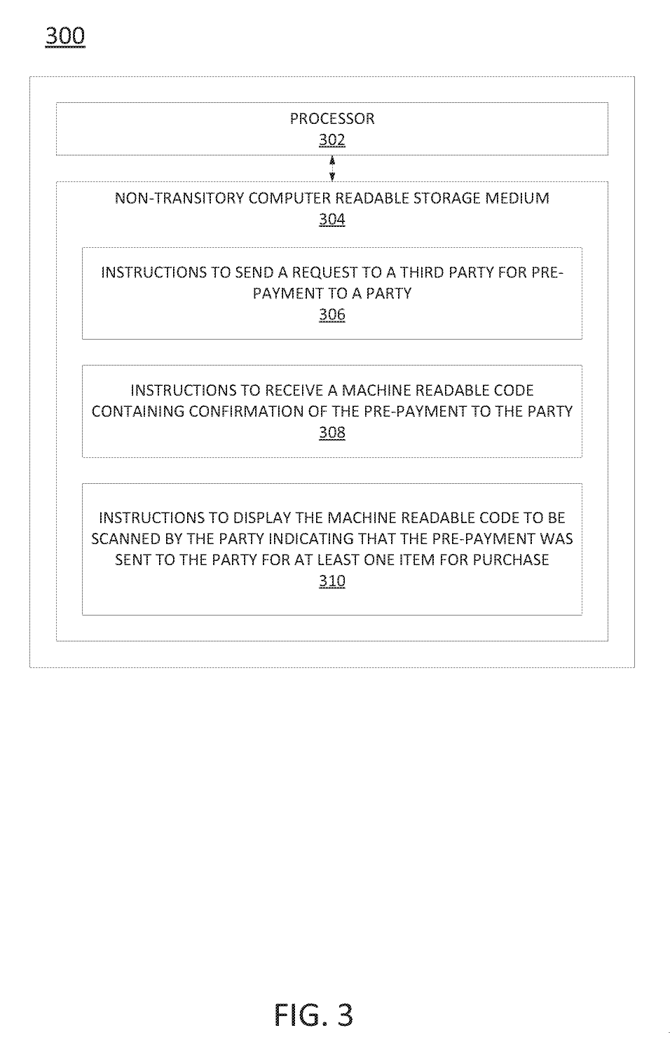

FIG. 3 illustrates another example of an apparatus 300. In one example, the apparatus 300 may also be the endpoint device 114. In one example, the apparatus 300 may include a processor 302 and a non-transitory computer readable storage medium 304. The non-transitory computer readable storage medium 304 may include instructions 306, 308 and 310 that when executed by the processor 302, cause the processor 302 to perform various functions.

In one example, the instructions 306 may include instructions to send a request to a third party (e.g., a third party financial service provider) for pre-payment to a party (e.g., a retailer). The instructions 308 may include instructions to receive a machine readable code containing confirmation of the pre-payment to the party. The instructions 310 may include instructions to display the machine readable code to be scanned by the party indicating that the pre-payment was sent to the party for at least one item for purchase.

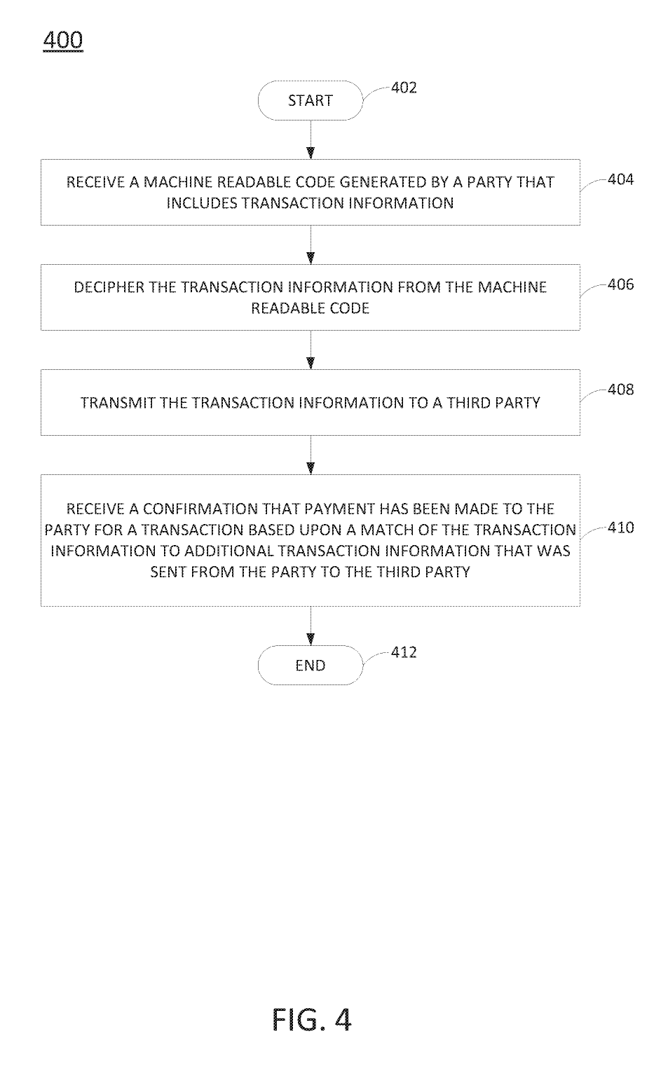

FIG. 4 illustrates a flow diagram of an example method 400 for matching transaction information for payment from a perspective of a consumer. In one example, the blocks of the method 400 may be performed by the endpoint device 114 or the apparatus 200.

At block 402, the method 400 begins. At block 404, the method 400 receives a machine readable code generated by a party (e.g., a retailer) that includes transaction information. In one example, the machine readable code may be a QR code that is scanned by the endpoint device of the consumer from a receipt, a display of a POS device of the retailer, from a checkout webpage for an online transaction with the retailer, and the like. The transaction information may include a store identification (e.g., a store name, a store number, and the like), a transaction identification (e.g., a unique numerical value associated with a particular transaction), an amount (e.g., a total amount of the transaction), and the like.

At block 406, the method 400 deciphers the transaction information from the machine readable code. For example, an application on the endpoint device of the consumer may obtain the transaction information from the QR code that was scanned.

At block 408, the method 400 transmits the transaction information to a third party (e.g., a third party financial service provider). In one example, the transaction information transmitted by the endpoint device of the consumer may include the transaction information that was deciphered from the scanned QR code and additional information (e.g., a GPS location of the endpoint device of the consumer, a user ID of the consumer, and the like). In some implementations, the transmission may be a wired or wireless transmission over the Internet and can be encrypted for security.

At block 410, the method 400 receives a confirmation that payment has been made to the party for a transaction based upon a match of the transaction information to additional transaction information that was sent from the party to the third party. For example, the retailer may also send transaction information to the third party financial service provider associated with the transaction. The third party financial service provider may compare the received transaction information to determine that the transaction information matches (e.g., within a threshold value for some transaction information). If the transaction information matches, the third party financial service provider may transfer funds from a financial account associated with the consumer to a financial account associated with the retailer and send the confirmation that the funds have been transferred. At block 412, the method 400 ends.

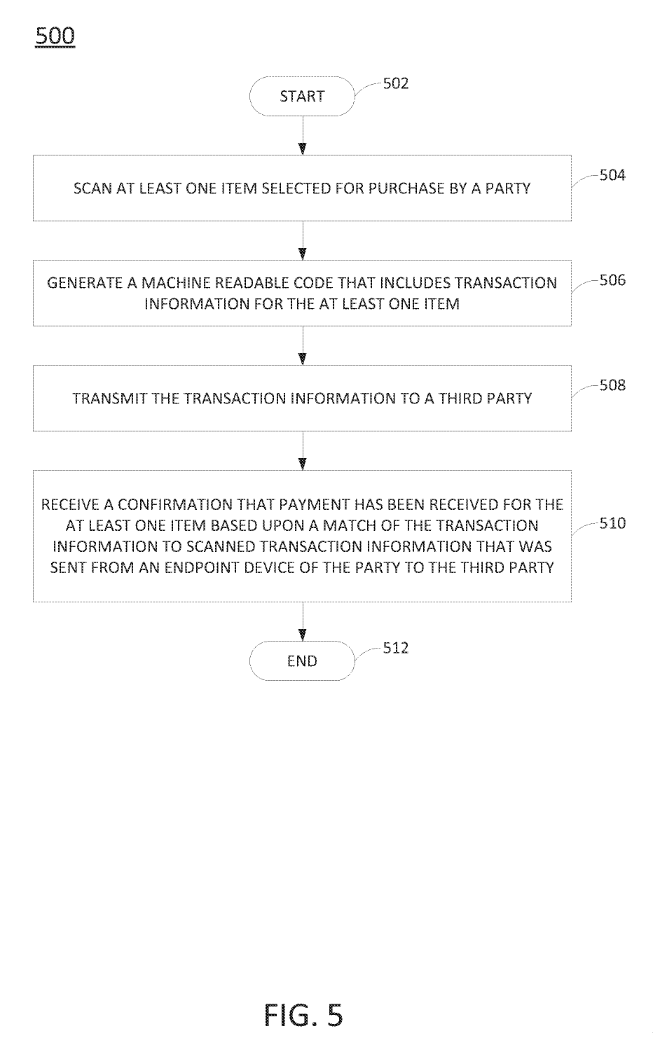

FIG. 5 illustrates a flow diagram of an example method 500 for matching transaction information for payment from a perspective of a retailer. In one example, the blocks of the method 500 may be performed by the POS device 110 at the retailer 108.

At block 502, the method 500 begins. At block 504, the method 500 scans at least one item selected for purchase by a party (e.g., a consumer). For example, the item or services can be scanned by the POS device or selected for an online transaction where the POS device is a website that hosts the webpage.

At block 506, the method 500 generates a machine readable code that includes transaction information for the at least one item. For example, the machine readable code may be a QR code. The machine readable code that is generated may be printed on a receipt, displayed on a display of the POS device, or displayed on a webpage of an online transaction such that the machine readable code can be scanned by an endpoint device of the consumer. In some implementations, the machine readable code may be electronically, or wirelessly, transmitted to the endpoint device.

At block 508, the method 500 transmits the transaction information to a third party (e.g., a third party financial service provider). In one example, the transaction information sent by the retailer may include a store identification, a store location, a transaction identification, an amount, and the like. The transaction information may also include financial account information associated with the retailer to receive fund or payment.

At block 510, the method 500 receives a confirmation that payment has been received for the at least one item based upon a match of the transaction information to scanned transaction information that was sent from an endpoint device of the party to the third party. For example, the consumer may also send transaction information to the third party financial service provider associated with the transaction. The third party financial service provider may compare the scanned transaction information from the consumer to determine that the transaction information matches (e.g., within a threshold value for some transaction information). If the transaction information matches, the third party financial service provider may transfer funds from a financial account associated with the consumer to a financial account associated with the retailer and send the confirmation that the funds have been transferred. At block 512, the method 500 ends.

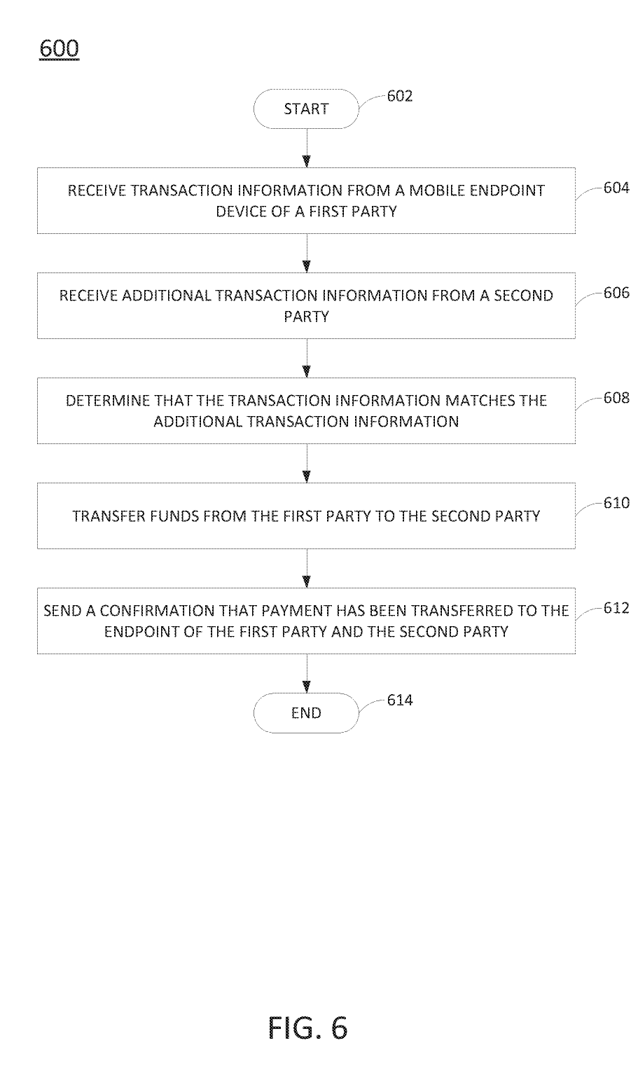

FIG. 6 illustrates a flow diagram of an example method 600 for matching transaction information for payment from a perspective of a third party financial service provider. In one example, the blocks of the method 600 may be performed by the AS 104 at the TPFSP 102.

At block 602, the method 600 begins. At block 604, the method 600 receives transaction information from a mobile endpoint device of a first party (e.g., a consumer). For example, the consumer may scan a machine readable code generated by a POS device of the retailer with an endpoint device. The endpoint device may decipher the machine readable code to obtain the transaction information and transmit the transaction information to the third party financial service provider.

At block 606, the method 600 receives additional transaction information from a second party (e.g., a retailer). For example, the retailer may transmit transaction information to the third party financial service provider independent from the consumer after all items are scanned or all services are rendered.

At block 608, the method 600 determines that the transaction information matches the additional transaction information. For example, the transaction information from the consumer may include a GPS location of the endpoint device, a store identification, a transaction identification, an amount, and the like. The transaction information from the retailer may include a store identification, a store location, a transaction identification, an amount, and the like. The third party financial service provider may compare each portion of the transaction information from the consumer and the retailer to confirm that each portion of the transaction information from the consumer and the retailer matches. In some implementations, threshold values may be used to provide some tolerance from an exact match. For example, the GPS location of the endpoint device and the store location may not be an exact match, but rather within a predefined threshold value.

At block 610, the method 600 transfer funds from the first party to the second party. For example, when the transaction information from the consumer and the additional transaction information from the retailer matches, the third party financial service provider may transfer funds. The transfer of funds may be from a financial account associated with the consumer to a financial account associated with the retailer.

At block 612, the method 600 may send a confirmation that payment has been transferred to the endpoint of the first party and the second party. For example, a confirmation may be sent to the endpoint device of the consumer and another confirmation may be sent to the POS device of the retailer. The confirmation may be sent via a wired or wireless connection. At block 614, the method 600 ends.

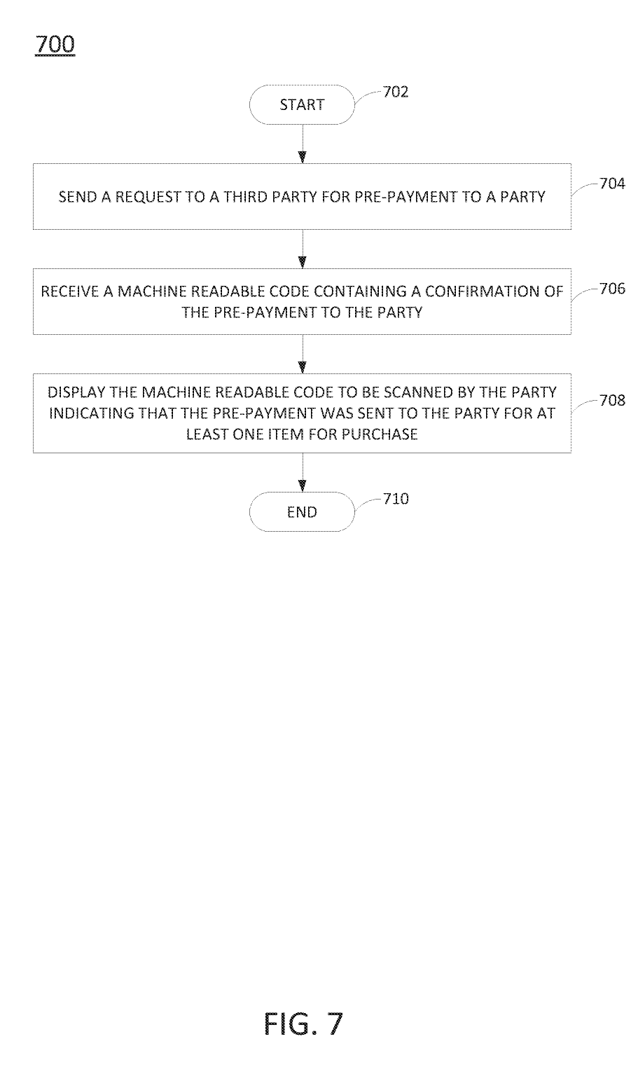

FIG. 7 illustrates a flow diagram of an example method 700 for pre-paying a retailer for an item. In one example, the blocks of the method 700 may be performed by the endpoint device 114 or the apparatus 300.

At block 702, the method 700 begins. At block 704, the method 700 sends a request to a third party (e.g., a third party financial service provider) for pre-payment to a party (e.g., a retailer). The request may include a name of the retailer, the location of the retailer, an amount, and the like. In one implementation, the third party service provider may contact the retailer to obtain financial account information of the retailer. The amount associated with the request for pre-payment may be transferred from a financial account associated with the consumer to the financial account associated with the retailer.

At block 706, the method 700 receives a machine readable code containing a confirmation of the pre-payment to the party. For example, the machine readable code may be a QR code.

At block 708, the method 700 displays the machine readable code to be scanned by the party indicating that the pre-payment was sent to the party for at least one item for purchase. For example, the retailer may scan and decipher the machine readable code to see that the pre-payment was confirmed. The items or services may then be provided to the consumer. At block 710, the method 700 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a processor; and
a non-transitory computer-readable storage medium comprising instructions that, when executed by the processor, cause the processor to:
receive a machine readable code generated by a party that includes transaction information;
decipher the transaction information from the machine readable code;
transmit the transaction information to a third party; and
receive a confirmation that a payment has been made to the party for a transaction based upon a match of the transaction information to additional transaction information that was sent from the party to the third party.

2. The apparatus of claim 1, wherein the machine readable code is scanned from a receipt, from a point of sale device at the party or a webpage of an online transaction.

3. The apparatus of claim 1, wherein the machine readable code comprises a quick response (QR) code.

4. The apparatus of claim 1, further comprising instructions to:
receive an authentication of a user.

5. The apparatus of claim 1, wherein the transaction information comprises a location information of a user, a store identification, a purchase amount and a transaction identification.

6. The apparatus of claim 1, wherein the additional transaction information comprises a store identification, a store location, a purchase amount and a transaction identification.

7. The apparatus of claim 1, further comprising instructions to:
transmit a user defined distress signal that indicates that the transaction information was transmitted under distress causing the payment to be canceled and causing the third party to contact an authority.

8. The apparatus of claim 1, further comprising instructions to:
transmit an amount threshold based via a fingerprint, wherein different fingerprints associated with different fingers are associated with different amount thresholds.

9. A method, comprising:
scanning, by a processor, at least one item selected for purchase by a party;
generating, by the processor, a machine readable code that includes transaction information for the at least one item;
transmitting, by the processor, the transaction information to a third party; and
receiving, by the processor, a confirmation that a payment has been received for the at least one item based upon a match of the transaction information to scanned transaction information that was sent from an endpoint device of the party to the third party.

10. The method of claim 9, wherein the machine readable code is printed on a receipt, a point of sale device or a webpage of an online transaction.

11. The method of claim 9, wherein the transaction information comprises a store location, a store identification, a purchase amount and a transaction identification.

12. The method of claim 11, wherein the store location comprises a location of the party for an online transaction based upon a consumer profile information obtained during a log in by the party to a webpage of a retailer.

13. The method of claim 9, wherein the scanned transaction information comprises a location information of the party, a store identification, a purchase amount and a transaction identification.

14. A non-transitory computer readable storage medium encoded with instructions executable by a processor of a mobile endpoint device, the non-transitory computer-readable storage medium comprising:
instructions to send a request to a third party for a pre-payment to a party;
instructions to receive a machine readable code containing confirmation of the pre-payment to the party; and
instructions to display the machine readable code to be scanned by the party indicating that the pre-payment was sent to the party for at least one item for purchase.

15. The non-transitory computer readable storage medium of claim 14, wherein the machine readable code comprises a quick response (QR) code.
